(19) United States
(12) Patent Application Publication
(10) Pub. No.: US 2023/0392671 A1
(43) Pub. Date: Dec. 7, 2023

(54) HANGING METAL FITTING AND METHOD FOR MANUFACTURING HANGING METAL FITTING

(71) Applicant: KITO CORPORATION, Yamanashi (JP)

(72) Inventors: Kosuke KOSUGA, Yamanashi (JP); Rika SUZUKI, Yamanashi (JP)

(73) Assignee: KITO CORPORATION, Yamanashi (JP)

(21) Appl. No.: 18/267,114

(22) PCT Filed: Dec. 13, 2021
(86) PCT No.: PCT/JP2021/045843

§ 371 Date: Jun. 14, 2023

(30) Foreign Application Priority Data
Dec. 15, 2020 (JP) 2020-207776

(51) Int. Cl. F16G 15/08

(52) U.S. Cl. CPC F16G 15/08

(57) ABSTRACT

A hanging fitting comprising a rotary fitting, the rotary fitting comprising: an anchor fitting; a rotary coupling member pivotally supported by the anchor fitting; a first bearing which supports the rotary coupling member rotatably; and a second bearing which supports the rotary coupling member rotatably, the rotary coupling member being provided with a rotary shaft part; the anchor fitting being provided with a fixing portion, and a fitting coupling part; the fitting coupling part being provided with a coupling recessed part; the first bearing comprising a circumscribed recessed groove, an inscribed recessed groove facing the circumscribed recessed groove, and a plurality of first bearing balls inserted into an endless passage; and the second bearing comprising a circumscribed step part, an inscribed step part facing the circumscribed step part, and a plurality of second bearing balls inserted into an endless passage.

### TECHNICAL FIELD

The present invention relates to a hanging fitting and a method for manufacturing the hanging fitting.

### BACKGROUND ART

There is something called a lifting point among hanging fittings for lifting a cargo. This hanging fitting includes an annular link, a rotary coupling member making a coupling portion of the link rotatable, and an anchor fitting rotatably supporting the rotary coupling member. Further, the anchor fitting is provided with a male threaded portion, and the male threaded portion is screwed into a female threaded portion of a mounting hole of the cargo. More specifically, there is one of cargoes which is provided with the female threaded portion such as a building component, a metal mold, or the like, and the male threaded portion is screwed and fixed into the female threaded portion of the cargo and a hook or the like is hung on a link member. This makes it possible to lift and move the cargo.

Incidentally, in the case of only one row of bearing arranged between the anchor fitting and the rotary coupling member, when a load acts in a direction (horizontal direction) perpendicular to a rotation axis, the rotary coupling member falls against the anchor fitting, whereby both of them directly slide. To prevent the direct slide, a bush is arranged between the anchor fitting and the rotary coupling member in some cases. However, the bush serves as a slide bearing, leading to deterioration in rotation performance between the anchor fitting and the rotary coupling member.

Hence, to prevent the deterioration in rotation performance, a hanging fitting having two rows of bearings is disclosed in Patent Literature 1. FIG. 5 of Patent Literature 1 discloses a configuration in which two rows of bearings (16, 17) are arranged between an outer peripheral side of a guide pin (24) of a mounting member (20) and an inner peripheral side of a recessed part (25) of a fixing member (21).

FIG. 1 of Patent Literature 1 discloses a configuration in which an upper side bearing (16) is arranged between an outer peripheral side of a guide pin (12) of a fixing member (13) and an inner peripheral side of a recessed part of a mounting member (1). In addition, the lower side bearing (17) is arranged between a flange-shaped portion of the fixing member (13) and a lower end surface of the mounting member (1).

Further, FIG. 8 of Patent Literature discloses a configuration in which the upper side bearing (17) is arranged between an upper end surface of a coupling member (29) and a step portion of the mounting member (20). In addition, the lower side bearing (16) is arranged between the outer peripheral side of the guide pin (24) of the mounting member (20) and an inner peripheral side of a recessed part (28) of the coupling member (29).

### CITATION LIST

### Patent Literature

{PTL 1} Japanese Translation of PCT International Application Publication No. 2005-513388 (see FIG. 1, FIG. 5 and FIG. 8)

### SUMMARY OF INVENTION

### Technical Problem

Incidentally, in the configuration disclosed in FIG. 5 of Patent Literature 1, when a load acts in the direction (horizontal direction) perpendicular to the rotation axis, an inner side (portion smaller in inside diameter) of a contact portion of the two rows of bearings (16, 17) of the guide pin (24) receives the load. In this case, it is necessary to increase the diameter of the guide pin (24) in order to resist a large load. However, if the diameter of the guide pin (24) is increased, the size of the hanging fitting is accordingly increased.

Further, in the configuration disclosed in FIG. 1 of Patent Literature 1, when a load acts in the direction (horizontal direction) perpendicular to the rotation axis, the flange-shaped portion of the fixing member (13) where the lower side bearing (17) is arranged can receive the load. This can decrease the dimension, of the guide pin (12) of the fixing member (13), on the inner side (portion smaller in inside diameter) of the contact portion with the bearing (16). However, in this configuration, in order to arrange the lower side bearing (17), it is necessary to form recess-shaped grooves in both the flange-shaped portion of the fixing member (13) and the lower end surface of the mounting member (1). However, in the case of forming the grooves, a space corresponding thereto is required and, as a result, the diameters of the fixing member (13) and the mounting member (1) need to be increased, leading to an increase in size of the hanging fitting.

Note that also in the configuration disclosed in FIG. 8 of Patent Literature 1, the same problem as in the configuration disclosed in FIG. 1 of Patent Literature 1 occurs. More specifically, it is necessary to form recess-shaped grooves in both the upper end surface of the coupling member (29) and the step portion of the mounting member (20) in order to arrange the upper side bearing (17) being the portion receiving the load in the direction (horizontal direction) perpendicular to the axial direction. However, in the case of forming the grooves, a space corresponding thereto is required and, as a result, the diameters of the coupling member (29) and the mounting member (20) need to be increased, leading to an increase in size of the hanging fitting.

The present invention has been made in consideration of the above circumstances, and its object is to provide a hanging fitting capable of preventing an increase in dimension though having two or more rows of bearings arranged and having an optimum bearing structure, and a method for manufacturing the hanging fitting.

### Solution to Problem

To solve the above problem, according to a first viewpoint of the present invention, there is provided a hanging fitting to be mounted on a cargo and including a rotary fitting to which a lifting means is to be coupled, the rotary fitting including: an anchor fitting to be fixed to a mounting surface of the cargo; a rotary coupling member pivotally supported by the anchor fitting on a rotation axis perpendicular to the mounting surface of the cargo; a first bearing which supports the rotary coupling member rotatably with respect to the anchor fitting; and a second bearing which supports the rotary coupling member rotatably with respect to the anchor fitting and is spaced apart from the first bearing in an axial direction of the rotation axis, the rotary coupling member being provided with a rotary shaft part which projects toward the anchor fitting; the anchor fitting being provided with a fixing portion to be mounted on the cargo, and a fitting coupling part integrated with the fixing portion; the fitting coupling part being provided with a coupling recessed part into which the rotary shaft part is inserted; the first bearing including a circumscribed recessed groove recessed from an inner wall surface of the coupling recessed part, an inscribed recessed groove recessed from an outer peripheral surface of the rotary shaft part and facing the circumscribed recessed groove, and a plurality of first bearing balls inserted into an endless passage formed by the inscribed recessed groove and the circumscribed recessed groove; and the second bearing including a circumscribed step part provided at an opening portion of the coupling recessed part into which the rotary shaft part is inserted, and recessed from an inside diameter side to an outside diameter side, an inscribed step part provided at a root portion of the rotary shaft part and facing the circumscribed step part, and a plurality of second bearing balls inserted into an endless passage formed by the circumscribed step part and the inscribed step part.

Further, in another aspect of the present invention, it is preferable in the above invention, that the fixing portion has an anchor seat part having a seat surface which comers into close contact with the mounting surface of the cargo.

Further, in another aspect of the present invention, it is preferable in the above invention, that a diameter of the second bearing ball is provided smaller than a diameter of the first bearing ball.

Further, in another aspect of the present invention, it is preferable in the above invention, that: a projecting part projecting toward the rotary coupling member projects around the opening portion of the coupling recessed part of the fitting coupling part; and a projecting height in the axial direction from a bottom portion of the circumscribed step part to a top part of the projecting part is provided larger than the diameter of the second bearing ball.

Further, in another aspect of the present invention, it is preferable in the above invention, that: the rotary coupling member is provided with a facing recessed part recessed from a second thrust surface facing the first thrust surface; and the projecting part enters the facing recessed part to form a labyrinth structure.

To solve the above problem, according to a second viewpoint of the present invention, there is provided a method for manufacturing a hanging fitting to be mounted on a cargo and including a rotary fitting to which a lifting means is to be coupled, the rotary fitting including: an anchor fitting to be fixed to a mounting surface of the cargo; a rotary coupling member pivotally supported by the anchor fitting on a rotation axis perpendicular to the mounting surface of the cargo; a first bearing which supports the rotary coupling member rotatably with respect to the anchor fitting; and a second bearing which supports the rotary coupling member rotatably with respect to the anchor fitting and is spaced apart from the first bearing in an axial direction of the rotation axis, the rotary coupling member being provided with a rotary shaft part which projects toward the anchor fitting; the anchor fitting being provided with a fixing portion to be mounted on the cargo, and a fitting coupling part integrated with the fixing portion; the fitting coupling part being provided with a coupling recessed part into which the rotary shaft part is inserted; the first bearing including a circumscribed recessed groove recessed from an inner wall surface of the coupling recessed part, an inscribed recessed groove recessed from an outer peripheral surface of the rotary shaft part and facing the circumscribed recessed groove, and a plurality of first bearing balls inserted into an endless passage formed by the inscribed recessed groove and the circumscribed recessed groove; and the second bearing including a circumscribed step part provided at an opening portion of the coupling recessed part into which the rotary shaft part is inserted, and recessed from an inside diameter side to an outside diameter side, an inscribed step part provided at a root portion of the rotary shaft part and facing the circumscribed step part, and a plurality of second bearing balls inserted into an endless passage formed by the circumscribed step part and the inscribed step part, the method executing: a shaft part insertion step of inserting the rotary shaft part into the coupling recessed part by a predetermined depth; before and after the shaft part insertion step, a jig arrangement step of arranging a jig at a facing section where the anchor fitting and the rotary coupling member face each other in a direction orthogonal to the axial direction to form at the facing section a gap in which the second bearing ball is movable; a preceding ball arrangement step of inserting the plurality of second bearing balls into the gap formed in the jig arrangement step and arranging the plurality of second bearing balls at the circumscribed step part; after the preceding ball arrangement step, a jig removal step of removing the jig from the facing section and inserting the rotary shaft part to a deep side of the coupling recessed part to bring both the circumscribed step part and the inscribed step part into contact with the second bearing ball; after the jig removal step, a subsequent ball arrangement step of inserting the plurality of first bearing balls through an input hole existing from an outer peripheral surface of the fitting coupling part to the circumscribed recessed groove to bring the plurality of first bearing balls into contact with both the circumscribed recessed groove and the inscribed recessed groove; and after the subsequent ball arrangement step, a sealing step of sealing the input hole.

### Advantageous Effects of Invention

According to the present invention, it is possible to provide a hanging fitting capable of preventing an increase in dimension though having two or more rows of bearings arranged and having an optimum bearing structure.

### BRIEF DESCRIPTION OF DRAWINGS

FIG. 1 is a perspective view illustrating a configuration of a hanging fitting according to an embodiment of the present invention.

FIG. 2 is a side view of the hanging fitting illustrated in FIG. 1.

FIG. 3 is an exploded perspective view illustrating the configuration of the hanging fitting illustrated in FIG. 1.

FIG. 4 is a cross-sectional view illustrating a configuration of a rotary fitting of the hanging fitting illustrated in FIG. 1.

FIG. 5 is an enlarged partial cross-sectional view illustrating bearings and a lower support part which face a fitting coupling part of the hanging fitting illustrated in FIG. 1.

FIG. 6 is an enlarged partial cross-sectional view of bearings and a lower support part which face a fitting coupling part relating to a modification example of FIG. 5.

FIG. 7 is a perspective view illustrating a state where a ring set is installed between an anchor fitting and the rotary coupling member for manufacturing the hanging fitting illustrated in FIG. 1.

FIG. 8 is a cross-sectional view in the state where the ring set is installed between the anchor fitting and the rotary coupling member illustrated in FIG. 7.

### DESCRIPTION OF EMBODIMENTS

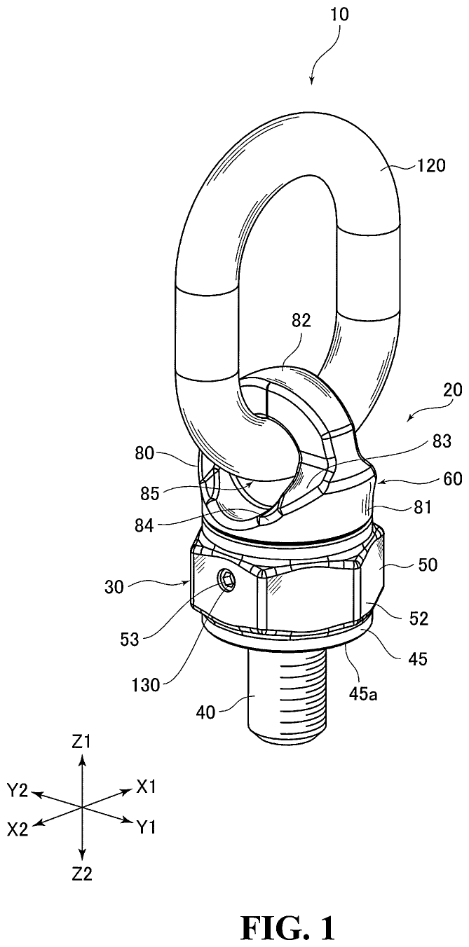

Hereinafter, a hanging fitting 10 according to an embodiment of the present invention will be explained with reference to the drawings. Note that in this embodiment, an extending direction of a link hole 85 is regarded as an X-direction, and an upper right side in FIG. 1 is regarded as an X1 side and a lower left side in FIG. 1 opposite thereto is regarded as an X2 side. Further, in FIG. 1, a direction linking both ends of an almost U-shaped upper annular part 82 is regarded as a Y-direction, and a lower right side in FIG. 1 is regarded as a Y1 side and an upper left side in FIG. 1 opposite thereto is regarded as a Y2 side. Further, an axial direction of a male threaded part 40 is regarded as a Z-direction, and a link coupling part 80 side when viewed from the male threaded part 40 is regarded as a Z1 side (upper side) and the male threaded part 40 side when viewed from the link coupling part 80 opposite thereto is regarded as a Z2 side (lower side).

### <Regarding a Configuration of the Hanging Fitting>

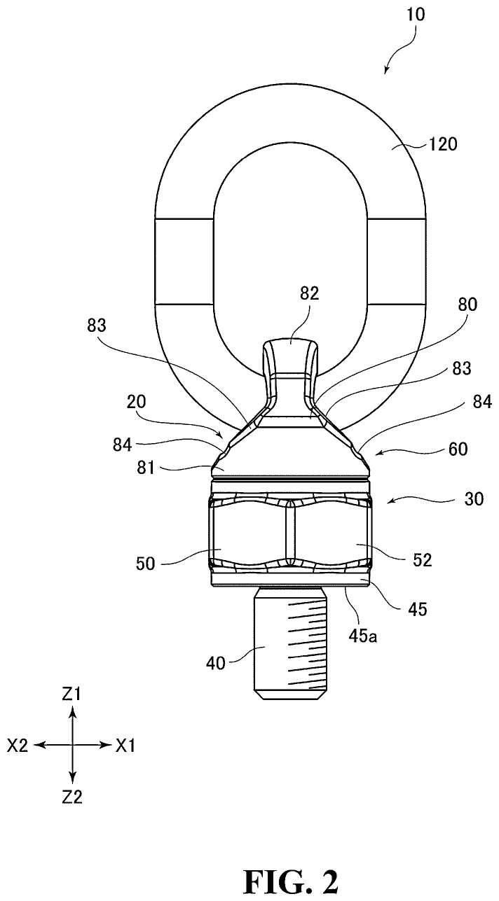

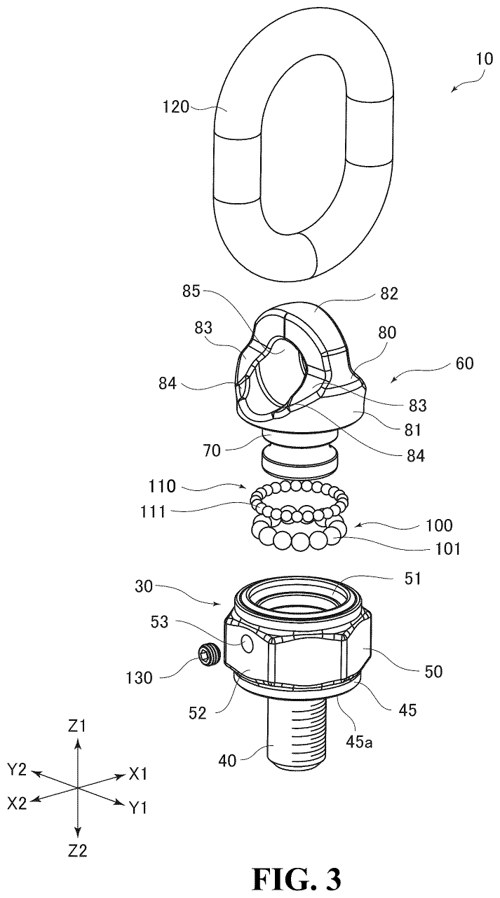

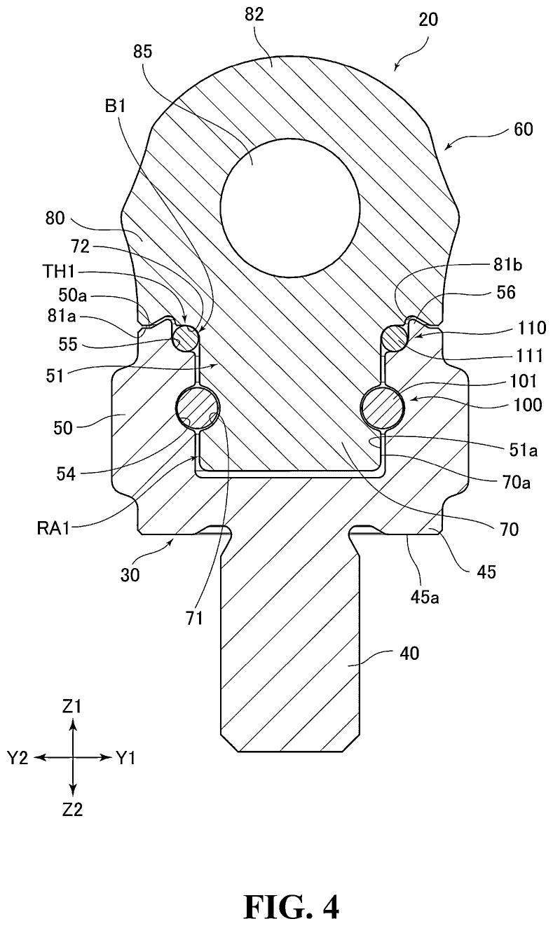

FIG. 1 is a perspective view illustrating a configuration of the hanging fitting 10. FIG. 2 is a side view illustrating the configuration of the hanging fitting 10. FIG. 3 is an exploded perspective view illustrating a configuration of a rotary fitting 20. FIG. 4 is a cross-sectional view illustrating the configuration of the rotary fitting 20. As illustrated in FIG. 1 to FIG. 4, the hanging fitting 10 has the rotary fitting 20 and a link 120. The rotary fitting 20 of them has an anchor fitting 30, a rotary coupling member 60, a first bearing 100, and a second bearing 110.

The anchor fitting 30 is a portion to be mounted on a not-illustrated cargo, and the anchor fitting 30 in this embodiment is provided in a shape of an almost hexagon bolt having a recess formed at the head portion. The anchor fitting 30 is provided with the male threaded part 40, a fitting coupling part 50 being a portion corresponding to the head portion of the hexagon bolt, and an anchor seat part 45. The male threaded part 40 is a shaft-shaped portion formed with threads, and the male threaded part 40 is screwed into a female thread provided in a mounting hole of the cargo. This fixes the anchor fitting 30 to the cargo.

Besides, the anchor fitting 30 is provided with the anchor seat part 45. Note that the male threaded part 40 and the anchor seat part 45 correspond to a fixing portion. The anchor seat part 45 is a portion having a seat surface 45a coming into contact with the mounting surface of the cargo. Therefore, the anchor seat part 45 is provided on an upper end side (Z1 side) of the male threaded part 40 and is integrated with the upper end side (Z1 side). The anchor seat part 45 is located on a lower side (Z2 side) of the fitting coupling part 50 and is integrated with the fitting coupling part 50. Note that as illustrated, for example, in FIG. 4, the anchor seat part 45 is provided in a circular ring shape around the male threaded part 40, but may be provided in a disk shape on the upper side (Z1 side) of the male threaded part 40 on the lower side (Z2 side) of the fitting coupling part 50.

Besides, the fitting coupling part 50 is a portion coupled with the rotary coupling member 60. As illustrated in FIG. 3, the fitting coupling part 50 is provided with a coupling recessed part 51 in a recess shape, and a rotary shaft part 70 of the rotary coupling member 60 enters the coupling recessed part 51. Note that an outer peripheral part 52 is provided on an outer peripheral side of the fitting coupling part 50. The outer peripheral part 52 is provided in a shape (for example, hexagonal prismatic shape) fittable with a tool such as a wrench, and fitting an action portion of the tool with the outer peripheral part 52 improves the workability when screwing and fastening the male threaded part 40 into the female threaded portion of the cargo.

Further, the fitting coupling part 50 is provided with an input hole 53 (see FIG. 3). Through the input hole 53, a plurality of bearing balls 101 (later explained) constituting the first bearing 100 are inserted. Further, the input hole 53 is a threaded hole, and a hexagon socket head screw 130 for sealing (hereinafter, simply called a screw 130) is screwed into the input hole 53. This prevents the falling out of the bearing balls 101.

Further, on the inner wall side of the coupling recessed part 51, a circumscribed recessed groove 54 and a circumscribed step part 55 are provided. Note that the circumscribed recessed groove 54 and the circumscribed step part 55 will be explained later.

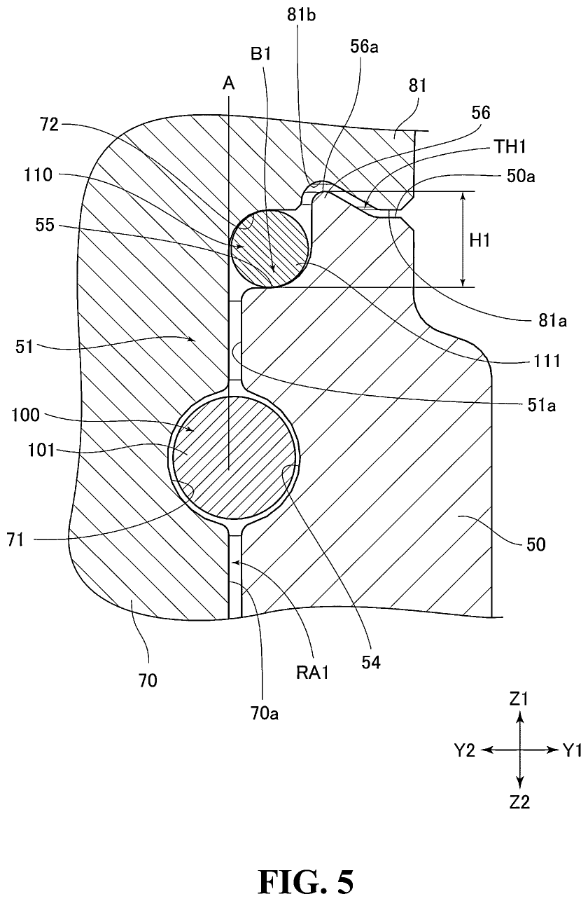

FIG. 5 is an enlarged partial cross-sectional view of the first bearing 100, the second bearing 110, and a lower support part 81 which face the fitting coupling part 50. As illustrated in FIG. 4 and FIG. 5, a projecting part 56 projecting to the upper side (Z1 side) more than the circumscribed step part 55 is provided around the vicinity of an opening part of the coupling recessed part 51 of the fitting coupling part 50. The projecting part 56 is provided with a top part 56a, and the top part 56a is a portion located on the uppermost side (Z1 side) closer to the coupling recessed part 51 than the outer peripheral side of the fitting coupling part 50. Further, a height dimension H1 from the top part 56a to the circumscribed step part 55 is provided larger than the diameter of the later-explained bearing ball 111. Therefore, it is structured to protect the bearing balls from intrusion of foreign matters from the outside and to retain a lubricant.

Note that the projecting part 56 enters a later-explained annular recessed part 81b and forms a labyrinth structure. This further improves the prevention of the intrusion of foreign matters to the second bearing 110 and the retention of the lubricant.

As illustrated in FIG. 1 to FIG. 4, the rotary coupling member 60 is provided with the rotary shaft part 70 and the link coupling part 80. The rotary shaft part 70 is a shaft-shaped portion inserted into the coupling recessed part 51 of the anchor fitting 30. The insertion of the rotary shaft part 70 into the coupling recessed part 51 to form a radial facing portion RA1 where an outer peripheral surface 70a of the rotary shaft part 70 and an inner wall surface 51a of the coupling recessed part 51 face each other in the radial direction. Further, a lower surface 81a of the lower support part 81 and an upper surface 50a around the coupling recessed part 51 of the fitting coupling part 50 face each other to form a thrust facing portion TH1. Note that the upper surface 50a corresponds to a first thrust surface and the lower surface 81a corresponds to a second thrust surface.

Between the rotary shaft part 70 and the coupling recessed part 51, the plurality of bearing balls 101 constituting the first bearing 100 and a plurality of bearing balls 111 constituting the second bearing 110 are arranged. Thus, the rotary coupling member 60 is rotatable around the axial center of the rotary shaft part 70 with respect to the anchor fitting 30.

Note that the rotary shaft part 70 is provided with an inscribed recessed groove 71 and an inscribed step part 72, and the inscribed recessed groove 71 and the inscribed step part 72 will be explained later.

Further, the link coupling part 80 is a portion located on a side (Z1 side) further away from the from the anchor fitting 30 than the rotary shaft part 70 in the rotation axis direction (Z-direction) of the link coupling part 80. The link coupling part 80 has the lower support part 81, the upper annular part 82, an inclined shoulder part 83, a link receiving part 84, and the link hole 85.

The lower support part 81 is a portion, of the rotary coupling member 60, located on the anchor fitting 30 side, and provided in an almost circular plate shape. In this embodiment, at a portion, of the lower support part 81, opposite to the anchor fitting 30, the later-explained inclined shoulder part 83 and link hole 85 are formed by cutting parts of a circular cylindrical shape. Note that a portion cut into an almost circular cylindrical shape from the upper side (Z1 side) toward the lower side (Z2 side) of the lower support part 81 is a part of the link hole 85.

Further, on the lower surface 81a side of the lower support part 81, the annular recessed part 81b is provided. The annular recessed part 81b is a portion adjacent to the outside diameter side of the inscribed step part 72 and recessed toward the upper side (Z1 side) and is a portion which the projecting part 56 enters. Note that the projecting part 56 and the annular recessed part 81b form the labyrinth structure as explained above to prevent foreign matters such as dust from entering the second bearing 110 side. Further, the lubricant at bearing portions such as the second bearing 110 and the first bearing 100 is prevented from leaking out. Note that the annular recessed part 81b corresponds to a facing recessed portion.

Further, on the upper side (surface side on the Z1 side) of the lower support part 81, the upper annular part 82 is provided. One end side and the other end side of the almost U-shape of the upper annular part 82 are coupled with the lower support part 81 to form the link hole 85 surrounded by the lower support part 81 and the upper annular part 82. Note that when viewing the link hole 85 in front view, its shape is a circular shape. However, the front view shape of the link hole 85 is not limited to the circular shape but it may be provided in an oval shape or an elliptical shape.

Further, the inclined shoulder part 83 is provided near the boundary between the lower support part 81 and the upper annular part 82 and is inclined with respect to a ZY-plane parallel to both the Z-direction and the Y-direction. In this embodiment, the shape of the rotary coupling member 60 in plan view is symmetrical in the X-direction and the Y-direction. Therefore, a total of four boundaries between the lower support part 81 and the upper annular part 82 exist, and therefore a total of four inclined shoulder part 83 also exist.

Further, the link receiving part 84 is provided on the lower side (Z2 side) of the inclined shoulder part 83. The link receiving part 84 is a portion which comes into contact with the link 120 when the link 120 in a free state turns with an insertion portion into the link hole 85 as a fulcrum, to inhibit the link 120 from turning toward the male threaded part 40 side (lower side: Z2 side).

### <Regarding the First Bearing 100 and the Second Bearing 110>

Next, the first bearing 100 and the second bearing 110 will be explained. As illustrated in FIG. 3 and FIG. 4, the first bearing 100 includes the circumscribed recessed groove 54 provided at the fitting coupling part 50, the inscribed recessed groove 71 provided at the rotary shaft part 70, and the plurality of bearing balls 101. Besides, the second bearing 110 includes the circumscribed step part 55 provided at the fitting coupling part 50, the inscribed step part 72 provided at the rotary shaft part 70, and the plurality of bearing balls 111.

The circumscribed recessed groove 54 is a groove-shaped portion obtained by recessing the inner wall surface 51a facing the coupling recessed part 51, and the plurality of bearing balls 101 constituting the first bearing 100 are arranged therein in a manner to be rollable. As illustrated in FIG. 4, the circumscribed recessed groove 54 is provided at the middle portion in the height direction of the inner wall surface 51a. The circumscribed recessed groove 54 is a recessed portion in an arc shape (almost semi-circular shape in FIG. 4), and its curvature radius is provided equal to the radius of the later-explained bearing ball 101 or slightly larger than the radius of the bearing ball 101.

The inscribed recessed groove 71 is arranged to face the circumscribed recessed groove 54. The inscribed recessed groove 71 is a groove-shaped portion obtained by recessing the outer peripheral surface 70a, of the rotary shaft part 70, facing the circumscribed recessed groove 54, and the plurality of bearing balls 101 are arranged in a manner to be rollable. The inscribed recessed groove 71 is also a recessed portion in an arc shape (almost semi-circular shape in FIG. 4) similar to the circumscribed recessed groove 54, and its curvature radius is provided equal to the radius of the later-explained bearing ball 101 or slightly larger than the radius of the bearing ball 101.

Note that the circumscribed recessed groove 54 and the inscribed recessed groove 71 are formed at the radial facing portion RA1 where the inner wall surface 51a and the outer peripheral surface 70a face each other.

Further, the bearing ball 101 corresponds to a first bearing ball. The plurality of bearing balls 101 are inserted between the circumscribed recessed groove 54 and the inscribed recessed groove 71, and the bearing balls 101 are in a state of being movable therein. Further, between the circumscribed recessed groove 54 and the inscribed recessed groove 71, the bearing balls 101 are densely arranged in a manner to prevent generation of a gap between the bearing balls 101.

With this configuration, the first bearing 100 has a structure having a groove deeper than a configuration similar to a radial bearing and capable of receiving a large thrust load as well as a radial load.

Besides, the circumscribed step part 55 constituting the second bearing 110 is provided at the opening portion of a portion, of the coupling recessed part 51, into which the rotary shaft part 70 is inserted. More specifically, the circumscribed step part 55 is provided at a boundary portion B1 between the radial facing portion RA1 and the thrust facing portion TH1. Note that the circumscribed step part 55 is provided at the opening portion of the coupling recessed part 51, whereby the inside diameter of the opening portion is provided larger than the inside diameter of the other portion of the coupling recessed part 51.

An R-shaped portion exists at the circumscribed step part 55, and the plurality of bearing balls 111 constituting the second bearing 110 can come into contact with the R-shaped portion. More specifically, the plurality of bearing balls 111 roll along the R-shaped portion of the endless circumscribed step part 55. As explained above, the circumscribed step part 55 is located at the opening portion of the coupling recessed part 51, whereby the circumscribed step part 55 is apart from the above circumscribed recessed groove 54 by a certain distance in the vertical direction (Z-direction). Note that the curvature radius of the arc-shaped portion of the circumscribed step part 55 is provided equal to the radius of the later-explained bearing ball 111 or slightly larger than the radius of the bearing ball 111.

Further, the inscribed step part 72 constituting the second bearing 110 is an R-shaped portion provided at a portion facing the circumscribed step part 55 at a root portion on the upper end side of the rotary shaft part 70, and the plurality of bearing balls 111 constituting the second bearing 110 roll therein. The curvature radius of the R-shaped portion of the inscribed step part 72 is provided equal to the radius of the later-explained bearing ball 111 or slightly larger than the radius of the bearing ball 111.

Further, the bearing ball 111 corresponds to a second bearing ball. The plurality of bearing balls 111 are inserted between the circumscribed step part 55 and the inscribed step part 72, and the bearing balls 111 are in a state of being movable therein. Further, between the circumscribed step part 55 and the inscribed step part 72, the bearing balls 111 are densely arranged in a manner to prevent generation of a gap between the adjacent bearing balls 111. Note that as illustrated in FIG. 4, the bearing ball 111 is arranged to come into contact with both the circumscribed step part 55 in the R-shape and the inscribed step part 72 in the same R-shape, whereby the load acting on the bearing ball 111 is in a direction inclined about 45 degrees with respect to the axial direction of the male threaded part 40. Thus, the bearing ball 111 has a configuration similar to an angular bearing capable of receiving both loads such as the radial load and the thrust load.

Besides, the diameter of the bearing ball 111 is provided smaller than the diameter of the bearing ball 101. This makes it possible to increase the dimension (thickness) from the circumscribed step part 55 to the outer peripheral surface of the fitting coupling part 50. This can reduce the size of the hanging fitting 10. On the other hand, if the diameter of the bearing ball 111 is made too small, the bearing ball 111 runs out to the outside after wearing.

To reduce the size and prevent the bearing ball 111 from running out to the outside after wearing as above, it is preferable to set the ratio between the diameter of the bearing ball 101 and the diameter of the bearing ball 111 as follows. Note that in the following, the diameter of the bearing ball 111 is assumed to be a diameter D1 and the diameter of the bearing ball 101 is assumed to be a diameter D2.

Diameter D1:diameter D2=1:1.2 to 1.8

Note that the most preferable in the above range is about diameter D1:diameter D2=1:1.6.

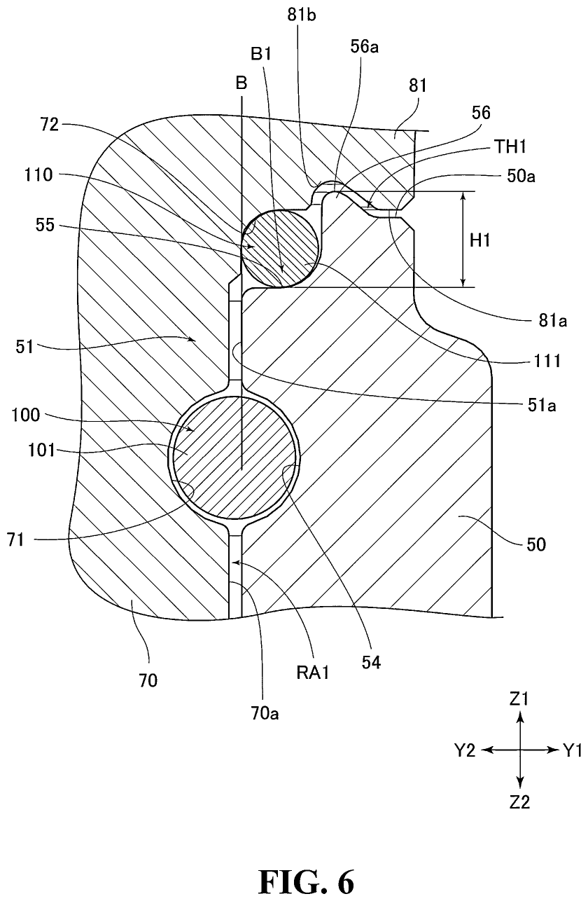

Besides, the position where the most inside diameter side of the bearing ball 111 is in contact with the rotary shaft part 70 preferably exists between a tangent A illustrated in FIG. 5 and a tangent B illustrated in FIG. 6. FIG. 6 is an enlarged partial cross-sectional view of the first bearing 100, the second bearing 110, and the lower support part 81 which face the fitting coupling part 50 relating to a modification example of FIG. 5.

In FIG. 5, a distance from the center of the rotary shaft part 70 to the outer peripheral surface 70a and a distance from the center of the rotary shaft part 70 to the tangent A are equal. On the other hand, in FIG. 6, a distance from the center of the rotary shaft part 70 to the inner wall surface 51a and a distance from the rotary shaft part 70 to the tangent B are equal. Accordingly, the position where the most inside diameter side of the bearing ball 111 is in contact with the rotary shaft part 70 may be a projecting portion that projects to the outside diameter side more than the outer peripheral surface 70a, but the projecting portion is preferably in a state of not projecting to the outside diameter side more than the inner wall surface 51a.

The reason why the position where the most inside diameter side of the bearing ball 111 is in contact with the rotary shaft part 70 exists between the tangent A and the tangent B as explained above is as follows. Specifically, various capacities (rated loads) exist in the hanging fittings 10, and in order to use a ready-made bearing ball 111 for the hanging fitting 10 having each of such capacities, a fine adjustable range is necessary. Further, in the case of arranging the bearing ball 111 in contact with the rotary shaft part 70 and the lower surface 81a (lower surface 81a on a side closer to the middle in the radial direction than the annular recessed part 81b) of the rotary coupling member 60, it is preferable that the bearing ball 111 is located in a range between the tangent A and the tangent B in order to prevent the generation of a gap between the bearing balls 111 as much as possible.

For example, if the position where the most inside diameter side of the bearing ball 111 is in contact with the rotary shaft part 70 exists in a dimensional range larger than the dimension between the tangent A and the tangent B, a large gap is more likely to be formed on the opposite side to the orientation in which the hanging fitting 10 is pulled by the horizontal pulling, and the bearing ball 111 becomes easier to move to the opposite side. On the other hand, if the dimension between the tangent A and the tangent B is small, the fine adjustable range for using the above ready-made bearing ball 111 is narrowed. Accordingly, it is preferable that the position where the most inside diameter side of the bearing ball 111 is in contact with the rotary shaft part 70 exists between the tangent A and the tangent B as explained above.

Besides, the position of the tangent B is set so that the rotary coupling member 60 does not overlap with the anchor fitting 30 (fitting coupling part 50). This avoids an increase in weight of the hanging fitting 10 while avoiding the interference between the rotary coupling member 60 and the anchor fitting 30 (fitting coupling part 50).

Note that in the case where the position where the most inside diameter side of the bearing ball 111 is in contact with the rotary shaft part 70 exists between the tangent A and the tangent B, by making the bearing ball 111 smaller in diameter than the bearing ball 101 smaller, it is possible to reduce the size of the hanging fitting 10 and increase the number of contact points of the bearing ball 111 in the case of horizontally pulling the hanging fitting 10. Thus, by making the contact points of the bearing ball 111 spun in a range as wide as possible in the case of horizontally pulling the hanging fitting 10, it becomes possible to support the rotary coupling member 60 so that it does not fall with respect to the anchor fitting 30.

Further, the link 120 is made into an endless elliptical shape by inserting a round-bar steel (steel wire) having a predetermined length into the link hole 85, bending it into an annular shape, and joining both ends (not illustrated) by welding or the like, and is coupled with the rotary coupling member 60. Besides, the screw 130 is a screw screwed into the input hole 53, and is preferably, for example, a hexagon socket head screw (setscrew).

### <Regarding a Method for Assembling (Method for Manufacturing) the Hanging Fitting 10>

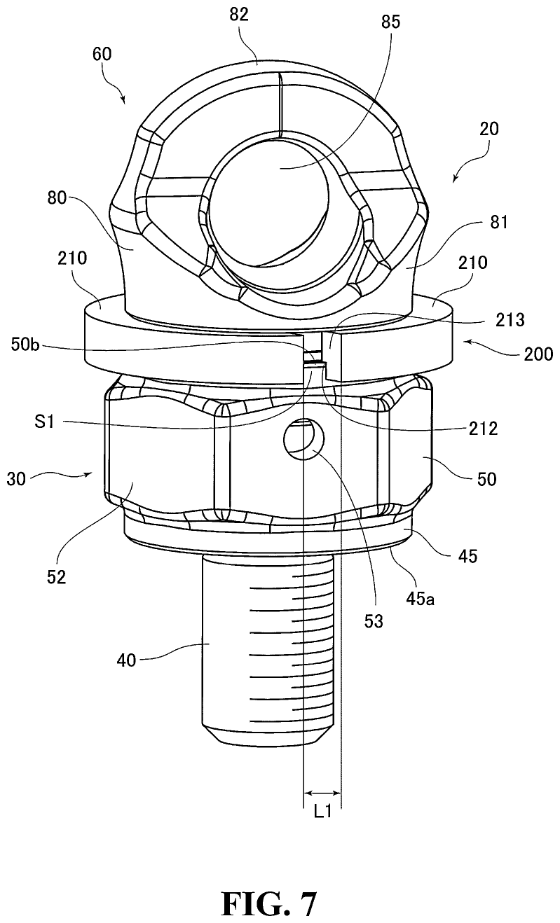

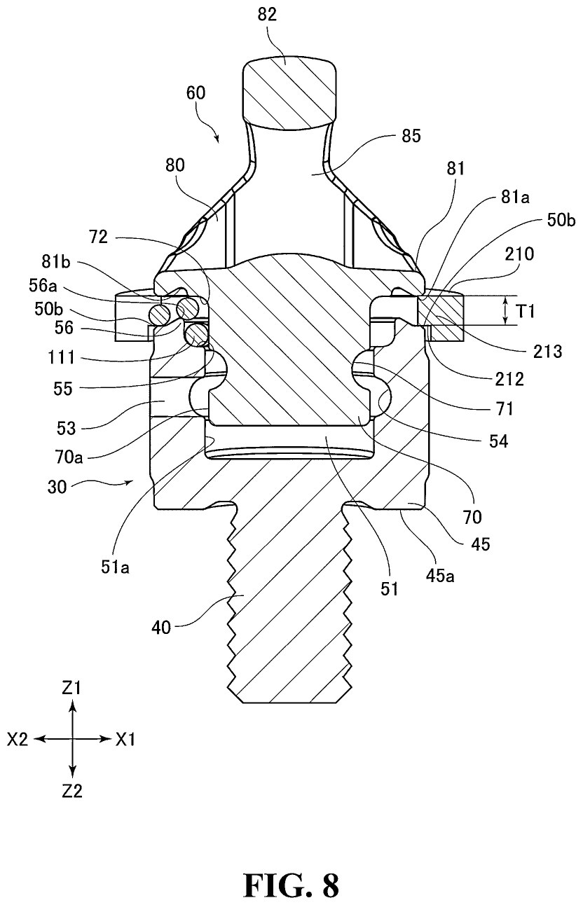

Next, a method for assembling (method for manufacturing) the hanging fitting 10 will be explained. When assembling the hanging fitting 10, the rotary shaft part 70 is first inserted into the coupling recessed part 51 (corresponding to a shaft part insertion step). Then, after the insertion by a predetermined depth, a ring set 200 corresponding to a jig as illustrated in FIG. 7 and FIG. 8 is installed between the anchor fitting 30 and the rotary coupling member 60 (corresponding to a jig arrangement step).

FIG. 7 is a perspective view illustrating a state where the ring set 200 is installed between the anchor fitting 30 and the rotary coupling member 60. FIG. 8 is a cross-sectional view illustrating the state where the ring set 200 is installed between the anchor fitting 30 and the rotary coupling member 60.

The ring set 200 illustrated in FIG. 7 and FIG. 8 is composed of a pair of half-rings 210. When viewing each of the half-rings 210 in plan view, its form is provided in a semi-circular shape. However, when end portion surfaces (sign omitted) located at end portion sides in the circumferential direction of the pair of half-rings 210 are butted, a gap S1 is formed between the pair of half-rings 210. A circumferential length L1 of the gap S1 is provided larger than the diameter of the bearing ball 111. This makes it possible to insert the bearing ball 111 from the gap S1 toward the gap formed by the circumscribed step part 55 and the inscribed step part 72.

Further, the half-ring 210 is provided with a engaging step part 212. The engaging step part 212 is a portion formed in a step-shape by cutting the inner peripheral side and the lower side (Z2 side) of the half-ring 210 so as to have a rectangular cross section. On the upper portion side of the engaging step part 212, a sandwich part 213 is provided. The sandwich part 213 is a portion sandwiched between the upper surface 50a of the fitting coupling part 50 and the lower surface 81a of the lower support part 81 as explained next. Note that a thickness dimension (dimension in the Z-direction) of the sandwich part 213 is larger than the diameter of the bearing ball 111. Further, a thickness dimension T1 of the sandwich part 213 is provided so that the interval between the lower surface 81a and the top part 56a is larger than the diameter of the bearing ball 111.

When the half-ring 210 having the above configuration is engaged to an upper corner part 50b of the fitting coupling part 50, the half-ring 210 is sandwiched between the lower surface 81a of the lower support part 81 and the upper surface 50a, of the fitting coupling part 50, located between the upper corner part 50b and the projecting part 56. Here, a thickness dimension (dimension in the Z-direction) of the sandwich part 213 is provided larger than the diameter of the bearing ball 111. This makes it possible to insert the bearing ball 111 from the above gap S1 to supply the bearing ball 111 to the gap between the circumscribed step part 55 and the inscribed step part 72. Accordingly, the bearing balls 111 are supplied in sequence from the gap S1 to the gap between the circumscribed step part 55 and the inscribed step part 72 (corresponding to a preceding ball arrangement step).

Note that when supplying the bearing ball 111, the bearing ball 111 is supplied while the rotary coupling member 60 is being rotated with respect to the anchor fitting 30, thereby making it possible to supply the plurality of bearing balls 111 while moving them in the ring-shaped gap between the circumscribed step part 55 and the inscribed step part 72. Further, prior to insertion of the rotary shaft part 70 into the coupling recessed part 51, the half-ring 210 may be engaged to the upper corner part 50b. Further, when supplying the bearing ball 111 to the ring-shaped gap between the circumscribed step part 55 and the inscribed step part 72, it is preferable to appropriately supply a lubricant.

Next, after the supply of a required number of bearing balls 111 from the gap S1, the half-ring 210 is removed from the space between the upper surface 50a and the lower surface 81a (corresponding to a jig removal step). This brings about a state where the rotary shaft part 70 is inserted to the deep side of the coupling recessed part 51 and the bearing ball 111 is sandwiched between the circumscribed step part 55 and the inscribed step part 72.

Thereafter, the bearing ball 101 is supplies to the gap between the circumscribed recessed groove 54 and the inscribed recessed groove 71 via the input hole 53 (corresponding to a subsequent ball arrangement step). This case is also performed while the rotary coupling member 60 is being rotated with respect to the anchor fitting 30, thereby making it possible to supply the plurality of bearing balls 101 while moving them in the ring-shaped gap between the circumscribed recessed groove 54 and the inscribed recessed groove 71. Note that, when supplying the bearing ball 101 to the ring-shaped gap between the circumscribed recessed groove 54 and the inscribed recessed groove 71, it is preferable to appropriately supply a lubricant.

Then, after the supply of the plurality of bearing ball 101 is completed, the screw 130 is screwed into the input hole 53 to seal the input hole 53 (corresponding to a sealing step). Thus, the assembly of the hanging fitting 10 is completed.

### Regarding Effects

In the hanging fitting 10 in the above configuration, the rotary fitting 20 includes the anchor fitting 30 to be fixed to the mounting surface of the cargo, the rotary coupling member 60 pivotally supported by the anchor fitting 30 on the rotation axis perpendicular to the mounting surface of the cargo, the first bearing 100 supporting the rotary coupling member 60 rotatably with respect to the anchor fitting 30, and the second bearing 110 supporting the rotary coupling member 60 rotatably with respect to the anchor fitting 30 and apart from the first bearing 100 in an axial direction of the rotation axis. The rotary coupling member 60 is provided with the rotary shaft part 70 which projects toward the anchor fitting 30, the anchor fitting 30 is provided with the male threaded part 40 and the anchor seat part 45 (fixing portion) to be mounted on the cargo, and the fitting coupling part 50 integrated with the male threaded part 40 and the anchor seat part 45 (fixing portion), and the fitting coupling part 50 is provided with the coupling recessed part 51 into which the rotary shaft part 70 is inserted.

Further, the first bearing 100 includes the circumscribed recessed groove 54 recessed from the inner wall surface 51a of the coupling recessed part 51, the inscribed recessed groove 71 recessed from the outer peripheral surface of the rotary shaft part 70 and facing the circumscribed recessed groove 54, and the plurality of bearing balls 101 (first bearing balls) inserted into an endless passage formed by the inscribed recessed groove 71 and the circumscribed recessed groove 54. Further, the second bearing 110 includes the circumscribed step part 55 provided at the opening portion of the coupling recessed part 51 into which the rotary shaft part 70 is inserted, and recessed from the inside diameter side to the outside diameter side, the inscribed step part 72 provided at the root portion of the rotary shaft part 70 and facing the circumscribed step part 55, and the plurality of bearing balls 111 (second bearing balls) inserted into an endless passage formed by the circumscribed step part 55 and the inscribed step part 72.

In the above configuration, the first bearing 100 composed of the circumscribed recessed groove 54, the inscribed recessed groove 71, and the bearing balls 101 (first bearing balls) is arranged on the internal side of the coupling recessed part 51. Further, the second bearing 110 composed of the circumscribed step part 55, the inscribed step part 72, and the bearing balls 111 (second bearing balls) is arranged at the opening portion of the coupling recessed part 51. This brings about a state where two rows of bearings are arranged between the anchor fitting 30 and the rotary coupling member 60. In addition, two step parts such as the circumscribed step part 55 and the inscribed step part 72 face each other at the opening portion of the coupling recessed part 51 and the root portion of the rotary shaft part 70, and the circumscribed step part 55 is not only provided at the opening portion of the coupling recessed part 51 but is recessed from the inside diameter side to the outside diameter side, whereby the second bearing 110 can be made to have a configuration similar to the angular bearing.

Here, in the case of having a configuration similar to the thrust bearing as illustrated in FIG. 1 and FIG. 8 of Patent Literature 1, a recess-shaped groove for inserting the bearing ball is required, and an embankment portion for inhibiting the movement of the bearing balls is required on the inside diameter side and the outside diameter side across the recess-shaped groove. Accordingly, two embankment portions on the outside diameter side and the inside diameter side are required, so that the dimension in the radial direction accordingly increases. However, in this embodiment, the circumscribed step part 55 is not only provided at the opening portion of the coupling recessed part 51 but is recessed from the inside diameter side to the outside diameter side in the second bearing 110, and therefore the embankment portion for inhibiting the movement of the bearing balls exists only on the outside diameter side. This makes it possible to reduce the size of the second bearing 110.

Further, in the case where a load (horizontal load) acts in the Y-direction (horizontal direction) in the state where the link 120 falls (the state where the long side of the link 120 is along the Y-direction illustrated in FIG. 1), the horizontal load can be received by the second bearing 110 having the configuration similar to the angular bearing. Note that the bearing balls 111 are pressed along the axial direction (Z-direction) being a direction crossing the radial direction or a direction inclined to the radial direction in this event. Therefore, as in the case illustrated in FIG. 5 of Patent Literature 1, the load can be received closer to the outside diameter side than in the state where the load is received on the inside diameter side of the bearing ball 111. The load can be received closer to the outside diameter side than in the state where the load is received on the inside diameter side of the bearing ball 111 as above, thereby making it possible to accordingly reduce the dimension of the hanging fitting 10. This can reduce the size of the hanging fitting 10.

Further, in this embodiment, the fixing portion including the male threaded part has the anchor seat part 45 having the seat surface 45a which comers into close contact with the mounting surface of the cargo. In this configuration, the seat surface of the anchor seat part 45 comes into contact with the mounting surface of the cargo, thereby making it possible to suitably mount the hanging fitting 10 to the cargo.

Further, in this embodiment, the diameter of the bearing ball 111 (second bearing ball) is provided smaller than the diameter of the bearing ball 101 (first bearing ball). Therefore, the external step part 55 and the inscribed step part 72 in which the bearing balls 111 (second bearing balls) are housed saves space. This can decrease the thickness of the fitting coupling part 50 to decease the dimension in the radial direction, and can decrease the dimension in the axial direction (Z-direction) of the fitting coupling part 50 and the dimension in the axial direction (Z-direction) of the rotary shaft part 70. This can reduce the size of the hanging fitting 10.

Further, in this embodiment, the projecting part 56 projecting from the upper surface 50a (thrust surface) toward the rotary coupling member 60 projects around the opening portion of the coupling recessed part 51 of the fitting coupling part 50, and a projecting height in the axial direction (Z-direction) from the bottom portion of the circumscribed step part 55 to the top part 56a of the projecting part 56 is provided larger than the diameter of the bearing ball 111 (second bearing ball).

In the above configuration, the projecting part 56 can prevent the bearing ball 111 (second bearing ball) from running out to the outside even if looseness due to wear increases between the anchor fitting 30 and the rotary coupling member 60 as the hanging fitting 10 is used.

Further, in this embodiment, the rotary coupling member 60 is provided with the annular recessed part 81b (facing recessed part) recessed from the lower surface 81a (second facing surface) facing the upper surface 50a (first facing surface), and the projecting part 56 enters the annular recessed part 81b (facing recessed part) to form the labyrinth structure.

As explained above, the projecting part 56 enters the annular recessed part 81b (facing recessed part) to form the labyrinth structure, thereby making it difficult for dust to enter from the outside toward the facing section of the circumscribed step part 55 and the inscribed step part 72. Therefore, it becomes possible to prevent a decrease in bearing performance due to the entrance of dust for a long period.

Further, the method for manufacturing the hanging fitting 10 in this embodiment executes: the shaft part insertion step of inserting the rotary shaft part 70 into the coupling recessed part 51 by a predetermined depth; and, before and after the shaft part insertion step, the jig arrangement step of arranging the half-rings 210 (jig) at the facing section where the anchor fitting 30 and the rotary coupling member 60 face each other in the direction orthogonal to the axial direction (Z-direction) to form at the facing section the gap in which the bearing ball 111 (second bearing ball) is movable. The method for manufacturing the hanging fitting 10 further executes: the preceding ball arrangement step of inserting the plurality of bearing balls 111 (second bearing balls) into the gap formed in the jig arrangement step and arranging the plurality of bearing balls 111 (second bearing balls) at the circumscribed step part 55; and, after the ball arrangement step, the jig removal step of removing the half-rings 210 (jig) from the facing section and inserting the rotary shaft part 70 to the deep side of the coupling recessed part 51 to bring both the circumscribed step part 55 and the inscribed step part 72 into contact with the bearing ball 111 (second bearing ball). The method for manufacturing the hanging fitting 10 further executes: after the jig removal step, the subsequent ball arrangement step of inserting the plurality of bearing balls 101 (first bearing balls) through the input hole 53 existing from the outer peripheral surface of the fitting coupling part 50 to the circumscribed recessed groove 54 to bring the plurality of bearing balls 101 (first bearing balls) into contact with both the circumscribed recessed groove 54 and the inscribed recessed groove 71; and after the subsequent ball arrangement step, the sealing step of sealing the input hole 53.

As explained above, in the jig arrangement step, the half-rings 210 (jig) are arranged at the facing section where the anchor fitting 30 and the rotary coupling member 60 face each other in the direction orthogonal to the axial direction (Z-direction) to form the gap in which the bearing ball 111 (second bearing ball) is movable, thereby facilitating the insertion work of the bearing balls 111 (second bearing balls). Further, in the subsequent ball arrangement step, the plurality of bearing balls 101 (first bearing balls) are inserted through the input hole 53 and supplied to the facing section of the circumscribed recessed groove 54 and the inscribed recessed groove 71, thereby facilitating the insertion work of the bearing balls 101 (first bearing balls). This can improve the productivity.

### Modification Examples

The embodiments of the present invention are explained above, and the present invention can be variously modified in addition to them. Hereinafter, the modifications will be explained.

In the above embodiment, the hanging fitting 10 includes the rotary fitting 20 and the link 120. However, a hanging fitting may be composed of only the rotary fitting 20.

Further, in the above embodiment, the fitting coupling part 50 of the anchor fitting 30 is provided with the coupling recessed part 51, the rotary coupling member 60 is provided with the rotary shaft part 70, and the rotary shaft part 70 is inserted into the coupling recessed part 51. However, the anchor fitting 30 may be provided with a portion corresponding to the rotary shaft part 70, and the rotary coupling member 60 may be provided with a portion corresponding to the coupling recessed part.

Further, the above embodiment discloses the configuration is disclosed in which two bearing portions such as the first bearing 100 and the second bearing 110 are provided. However, the number of bearing portions is not limited to two, and a configuration in which three or more bearing portions are provided may be employed.

Further, in the above embodiment, the distance from the center in the axial direction of the rotary shaft part 70 to the outside in the radial direction of the bearing ball 101 (first bearing ball) and the distance from the center in the axial direction of the rotary shaft part 70 to the outside in the radial direction of the bearing ball 111 (second bearing ball) are not particularly stated. Here, the distance to the outside in the radial direction of the bearing ball 101 (first bearing ball) may be smaller than the distance to the outside in the radial direction of the bearing ball 111 (second bearing ball), but it is preferable that the distance to the outside in the radial direction of the bearing ball 101 (first bearing ball) is equal to or larger than the distance to the outside in the radial direction of the bearing ball 111 (second bearing ball).

Further, in the above embodiment, the anchor seat part 45 is provided to be smaller than the outer peripheral part 52 in distance to the rotation axis center or to be equal to the outer peripheral part 52 in distance to the rotation axis center. However, the anchor seat part 45 may be provided to be larger than the outer peripheral part 52 in distance to the rotation axis center. Further, the form of the anchor seat part 45 is not limited to the circular ring-shape (disk shape) but may be, for example, a polygonal shape such as a triangle, a rectangle, or the like, or may be an elliptical shape, and other appropriate shape can be employed.

Further, in the case where the anchor seat part 45 is configured to be larger than the outer peripheral part 52 in distance to the rotation axis center, a mounting hole may be formed at a flange-shaped portion, projecting from the outer peripheral part 52, of the anchor seat part 45, and a separate mounting hole may be formed in the former mounting hole. In this case, a separate mounting bolt (corresponding to a fastening member) is inserted into the mounting hole and screwed into the threaded hole or the like of the cargo, thereby making it possible to mount the hanging fitting 10 to the cargo. In the case of this configuration, the seat surface 45a of the anchor seat part 45 can be configured to come into contact with the mounting surface of the cargo in a relatively large area. Therefore, when the strength of the mounting surface of the cargo is weak relative to the metallic hanging fitting 10, it is possible to prevent damage to the mounting surface of the cargo.

Further, in the above embodiment, the male threaded part 40 corresponds to a part of the fixing portion and is made to be screwed into the female thread formed in the mounting hole of the cargo. However, the fixing portion may be a shaft-shaped member not formed with the male thread in place of the male threaded part 40. In this case, the female thread does not need to be formed in the mounting hole of the cargo. In this case, for example, a wedge, a pin, or a snap ring may be used to prevent the shaft-shaped member from slipping out of the mounting hole of the cargo.

Note that in the case where the mounting hole is provided at the flange-shaped portion of the anchor seat part 45 as above, the male threaded part 40 made by forming threads on the shaft-shaped member may be made a simple shaft-shaped member by omitting the threads. In this case, a shaft-shaped member formed with no threads corresponds to the part of the fixing portion.

### REFERENCE SIGNS LIST

10 . . . hanging fitting, 20 . . . rotary fitting, 30 . . . anchor fitting, 40 . . . male threaded part (corresponding to part of fixing portion), 45 . . . anchor seat part (corresponding to part of fixing portion), 45a . . . seat surface, 50 . . . fitting coupling part, 50a . . . upper surface (corresponding to first thrust surface), 50b . . . upper corner part, 51 . . . coupling recessed part, 51a . . . inner wall surface, 52 . . . outer peripheral part, 53 . . . input hole, 54 . . . circumscribed recessed groove, 55 . . . circumscribed step part, 56 . . . projecting part, 56a . . . top part, 60 . . . rotary coupling member, 70 . . . rotary shaft part, 70a . . . outer peripheral surface, 71 . . . inscribed recessed groove, 72 . . . inscribed step part, 80 . . . link coupling part, 81 . . . lower support part, 81a . . . lower surface (corresponding to second thrust surface), 81b . . . annular recessed part (corresponding to facing recessed portion), 82 . . . upper annular part, 83 . . . inclined shoulder part, 84 . . . link receiving part, 85 . . . link hole, 100 . . . first bearing, 101 . . . bearing ball (corresponding to first bearing ball), 110 . . . second bearing, 111 . . . bearing ball (corresponding to second bearing ball), 120 . . . link, 130 . . . hexagon socket head screw, 200 . . . ring set, 210 . . . half-ring, 212 . . . engaging step part, 213 . . . sandwich part, B1 . . . boundary portion, RA1 . . . radial facing portion, S1 . . . gap, TH1 . . . thrust facing portion

1. A hanging fitting to be mounted on a cargo and comprising a rotary fitting to which a lifting means is to be coupled,
the rotary fitting comprising:
an anchor fitting to be fixed to a mounting surface of the cargo;
a rotary coupling member pivotally supported by the anchor fitting on a rotation axis perpendicular to the mounting surface of the cargo;
a first bearing which supports the rotary coupling member rotatably with respect to the anchor fitting; and
a second bearing which supports the rotary coupling member rotatably with respect to the anchor fitting and is spaced apart from the first bearing in an axial direction of the rotation axis,
the rotary coupling member being provided with a rotary shaft part which projects toward the anchor fitting;
the anchor fitting being provided with a fixing portion to be mounted on the cargo, and a fitting coupling part integrated with the fixing portion;
the fitting coupling part being provided with a coupling recessed part into which the rotary shaft part is inserted;
the first bearing comprising a circumscribed recessed groove recessed from an inner wall surface of the coupling recessed part, an inscribed recessed groove recessed from an outer peripheral surface of the rotary shaft part and facing the circumscribed recessed groove, and a plurality of first bearing balls inserted into an endless passage formed by the inscribed recessed groove and the circumscribed recessed groove; and
the second bearing comprising a circumscribed step part provided at an opening portion of the coupling recessed part into which the rotary shaft part is inserted, and recessed from an inside diameter side to an outside diameter side, an inscribed step part provided at a root portion of the rotary shaft part and facing the circumscribed step part, and a plurality of second bearing balls inserted into an endless passage formed by the circumscribed step part and the inscribed step part.

2. The hanging fitting according to claim 1, wherein
the fixing portion has an anchor seat part having a seat surface which comers into close contact with the mounting surface of the cargo.

3. The hanging fitting according to claim 1, wherein
a diameter of the second bearing ball is provided smaller than a diameter of the first bearing ball.

4. The hanging fitting according to claim 1, wherein:
a projecting part projecting from a first thrust surface orthogonal to the axial direction toward the rotary coupling member projects around the opening portion of the coupling recessed part of the fitting coupling part; and
a projecting height in the axial direction from a bottom portion of the circumscribed step part to a top part of the projecting part is provided larger than the diameter of the second bearing ball.

5. The hanging fitting according to claim 4, wherein:
the rotary coupling member is provided with a facing recessed part recessed from a second thrust surface facing the first thrust surface; and
the projecting part enters the facing recessed part to form a labyrinth structure.

6. A method for manufacturing a hanging fitting to be mounted on a cargo and comprising a rotary fitting to which a lifting means is to be coupled,
the rotary fitting comprising:
an anchor fitting to be fixed to a mounting surface of the cargo;
a rotary coupling member pivotally supported by the anchor fitting on a rotation axis perpendicular to the mounting surface of the cargo;
a first bearing which supports the rotary coupling member rotatably with respect to the anchor fitting; and
a second bearing which supports the rotary coupling member rotatably with respect to the anchor fitting and is spaced apart from the first bearing in an axial direction of the rotation axis,
the rotary coupling member being provided with a rotary shaft part which projects toward the anchor fitting;
the anchor fitting being provided with a fixing portion to be mounted on the cargo, and a fitting coupling part integrated with the fixing portion;
the fitting coupling part being provided with a coupling recessed part into which the rotary shaft part is inserted;
the first bearing comprising a circumscribed recessed groove recessed from an inner wall surface of the coupling recessed part, an inscribed recessed groove recessed from an outer peripheral surface of the rotary shaft part and facing the circumscribed recessed groove, and a plurality of first bearing balls inserted into an endless passage formed by the inscribed recessed groove and the circumscribed recessed groove; and
the second bearing comprising a circumscribed step part provided at an opening portion of the coupling recessed part into which the rotary shaft part is inserted, and recessed from an inside diameter side to an outside diameter side, an inscribed step part provided at a root portion of the rotary shaft part and facing the circumscribed step part, and a plurality of second bearing balls inserted into an endless passage formed by the circumscribed step part and the inscribed step part,
the method executing:
a shaft part insertion step of inserting the rotary shaft part into the coupling recessed part by a predetermined depth;
before and after the shaft part insertion step, a jig arrangement step of arranging a jig at a facing section where the anchor fitting and the rotary coupling member face each other in a direction orthogonal to the axial direction to form at the facing section a gap in which the second bearing ball is movable;
a preceding ball arrangement step of inserting the plurality of second bearing balls into the gap formed in the jig arrangement step and arranging the plurality of second bearing balls at the circumscribed step part;
after the preceding ball arrangement step, a jig removal step of removing the jig from the facing section and inserting the rotary shaft part to a deep side of the coupling recessed part to bring both the circumscribed step part and the inscribed step part into contact with the second bearing ball;
after the jig removal step, a subsequent ball arrangement step of inserting the plurality of first bearing balls through an input hole existing from an outer peripheral surface of the fitting coupling part to the circumscribed recessed groove to bring the plurality of first bearing balls into contact with both the circumscribed recessed groove and the inscribed recessed groove; and
after the subsequent ball arrangement step, a sealing step of sealing the input hole.

7. The hanging fitting according to claim 2, wherein
a diameter of the second bearing ball is provided smaller than a diameter of the first bearing ball.

8. The hanging fitting according to claim 2, wherein:
a projecting part projecting from a first thrust surface orthogonal to the axial direction toward the rotary coupling member projects around the opening portion of the coupling recessed part of the fitting coupling part; and
a projecting height in the axial direction from a bottom portion of the circumscribed step part to a top part of the projecting part is provided larger than the diameter of the second bearing ball.

9. The hanging fitting according to claim 3, wherein:
a projecting part projecting from a first thrust surface orthogonal to the axial direction toward the rotary coupling member projects around the opening portion of the coupling recessed part of the fitting coupling part; and
a projecting height in the axial direction from a bottom portion of the circumscribed step part to a top part of the projecting part is provided larger than the diameter of the second bearing ball.

10. The hanging fitting according to claim 7, wherein:
a projecting part projecting from a first thrust surface orthogonal to the axial direction toward the rotary coupling member projects around the opening portion of the coupling recessed part of the fitting coupling part; and
a projecting height in the axial direction from a bottom portion of the circumscribed step part to a top part of the projecting part is provided larger than the diameter of the second bearing ball.

11. The hanging fitting according to claim 8, wherein:
the rotary coupling member is provided with a facing recessed part recessed from a second thrust surface facing the first thrust surface; and
the projecting part enters the facing recessed part to form a labyrinth structure.

12. The hanging fitting according to claim 9, wherein:
the rotary coupling member is provided with a facing recessed part recessed from a second thrust surface facing the first thrust surface; and
the projecting part enters the facing recessed part to form a labyrinth structure.

13. The hanging fitting according to claim 10, wherein:
the rotary coupling member is provided with a facing recessed part recessed from a second thrust surface facing the first thrust surface; and
the projecting part enters the facing recessed part to form a labyrinth structure.
